(19) United States
(12) Patent Application Publication
(10) Pub. No.: US 2005/0142936 A1
(43) Pub. Date: Jun. 30, 2005

(54) Multi-layered printed circuit board with a spacer post for preventing engagement between circuit paths of circuit layers

(75) Inventors: Li-Fu Sung, SanChung City (TW); Wen-Huei Su, HsinTien City (TW)

Correspondence Address: Ladas & Parry, 26 West 61st Street, New York, NY, 10023, US

(73) Assignee: BENQ CORPORATION

(21) Appl. No.: 10/999,659

(22) Filed: Nov. 30, 2004

(30) Foreign Application Priority Data
Dec. 31, 2003 (TW) 92137628

(51) Int. Cl. H01R 13/73

(52) U.S. Cl. 439/564

(57) ABSTRACT

A multi-layered printed circuit board includes a base member, a lower layer disposed above the base member, an upper layer disposed above the lower layer, and a plurality of vertical spacer posts sandwiched between the lower and upper layers so as to space apart the lower and upper layers from each other. Each spacer post includes an upper portion having an end face abutting against the upper layer and being formed with an inner threaded hole extending inwardly and axially from the end face, and a threaded lower portion. The threaded lower portion of each of the spacer posts extends a through hole in the lower layer to fasten threadedly the base member, and defines an outer diameter that is greater an inner diameter defined by the inner threaded hole in the upper portion.

### FIELD OF THE INVENTION

The invention relates to a multi-layered printed circuit board, more particularly to a spacer post for preventing engagement between circuit paths of upper and lower circuit layers in the multi-layered printed circuit board.

### BACKGROUND OF THE INVENTION

A conventional printed circuit board includes a plurality of electronic components, and is generally formed with a plurality of circuit paths for establishing electrical connection among the electronic components. The number of circuit paths is restricted by and directly proportional to the entire surface area of the printed circuit board, i.e. the more the surface area, the more the circuit paths can be formed thereon. In order to provide multi-function purposes and high performance of the printed circuit board, more and more electronic components are required to be mounted on the printed circuit board. Hence, the number of circuit paths (the surface area) needs inevitably to be increased. However, it is against the trench of the manufacture wishes, since the present printed circuit boards are produced in compact size to facilitate transport or to minimize the occupying space thereof. To eliminate the size problem and under the given circumstances, the printed circuit boards of today are designed in multi-layered forms, thereby increasing the total surface area for forming the circuit paths and for assembling the electronic components thereon.

FIG. 1 shows a partly exploded view of a conventional printed circuit board used in an LCD device, and includes a base member 10 (generally an outer body of the LCD device), a lower circuit layer 20 disposed above the base member 10, an upper circuit layer 30 disposed above the lower circuit layer 20, a plurality of spacer posts 40 sandwiched between the upper and lower circuit layers 30,20 so as to prevent the circuit paths of the circuit layers 30,20 from engagement therebetween and so as to enhance heat-dissipation effect, and a plurality of fastening screws 50.

Referring to FIG. 2, each spacer post 40 has an upper portion 41 and a threaded lower portion 42. The threaded lower portion 42 of each of the spacer posts 40 extends through a hole 22 in the lower circuit layer 20 to fasten threadedly a threaded hole 12 in the base member 10 (not visible since the printed circuit board is exploded). The upper portion 41 of each of the spacer posts 40 has an upper end face 40b abutting against the upper circuit layer 30, and is formed with an inner threaded hole 44 that extends inwardly and axially from the end face 40b. Each of the fastener screws 50 extends through a hole 32 in the upper circuit layer 30, and engages the inner threaded hole 44 in the upper portion of a respective spacer post 40. Note that in the past, in order to lower the manufacture cost and quicken the production thereof, the threaded lower portion 42 and the inner threaded hole 44 in the upper portion of each spacer post are arranged in such a manner to have the same screw pitch and the same pitch inclination (i.e. the threaded lower portion 42 can engage the inner threaded hole 44). Under such an arrangement (after assembly), a static force F is resulted due to engagement between the fastener screw 50 (or the threaded lower portion 42) with the wall A defining the inner threaded hole 44 in the upper portion 41 or the threaded hole 12 in the base member 10, as best shown in FIG. 3A. The strength of the static for F may vary according to the materials of the spacer post 40, the fastener screw 50, and the base member 10.

When it is desired to remove the threaded lower portion 42 of the space post 40 from the base member 10 (or the fastener screw 50 from the spacer post 40), a torque (T) must be applied on the spacer post 40. The strength of the applied torque T should be greater than that of the static force F so as to rotate the spacer post 40 relative to the base member 10. Referring to FIG. 3B, since the strength of torque T=F×r (radius of the threaded lower portion 42 or radius of the inner threaded hole 44), the torque T required to remove the threaded lower portion 42 of the spacer post 40 from the base member 10 is equivalent to that for removing the fastener screw 50 from the space post 40 by virtue of the same radius of the fastener screw 50 and the threaded lower portion 42. Under such condition, removal of the fastener screw 50 from the upper circuit layer 30 by turning the former relative to the latter can accidentally result in simultaneous removal of the lower circuit layer 20 from the base member 10, thereby untimely and unnecessarily damaging the electronic components mounted on the upper and lower circuit layers 30, 20.

### SUMMARY OF THE INVENTION

Therefore, it is the object of the present invention is to provide a multi-layered printed circuit board having a spacer post that is sandwiched between upper and lower circuit layers and that can prevent untimely removal of the lower circuit from the printed circuit board during removal of the upper circuit layer from the printed circuit board.

According to the present invention, a multi-layered printed circuit board for an LCD device is provided to include: base member; a lower circuit layer disposed above the base member and formed with a plurality of through holes; an upper circuit layer disposed above the lower circuit layer and formed with a plurality of through holes; a plurality of vertical spacer posts disposed between the lower and upper circuit layers so as to space apart the circuit paths of the lower and upper circuit layers from each other, each of the spacer posts including an upper portion having an end face abutting against the upper circuit layer and being formed with an inner threaded hole extending inwardly and axially from the end face, and a threaded lower portion extending through a respective one of the through holes in the lower circuit layer to fasten threadedly the base member; and a plurality of fastener screws. Each of the fastener screws extends through a respective one of the through holes in the upper circuit layer to fasten threadedly the inner threaded hole in the upper portion of a respective one of the spacer posts. The threaded lower portion of each of the spacer posts defines an outer diameter that is greater an inner diameter defined by the inner threaded hole in the upper portion of a respective spacer post.

### BRIEF DESCRIPTION OF THE DRAWINGS

Other features and advantages of this invention will become more apparent in the following detailed description of the preferred embodiments of this invention, with reference to the accompanying drawings, in which:

FIG. 1 is a perspective partly exploded view of a conventional printed circuit board;

FIG. 2 is a cross-sectional view of the spacer post used to prevent engagement between circuit paths of upper and lower circuit layers in the conventional printed circuit board;

FIG. 3A illustrates how the spacer post of FIG. 2 engages a threaded hole in a base member of the conventional printed circuit board;

FIG. 3B is a top planar view, illustrating how the spacer post of FIG. 2 engages the threaded hole in a base member of the conventional printed circuit board;

FIG. 4 is a perspective partly exploded view of the preferred embodiment of a multi-layered printed circuit board according to the present invention;

FIG. 5 is a perspective partly exploded view of the modified preferred embodiment of the multi-layered printed circuit board according to the present invention;

FIG. 6 is an enlarged cross-sectional view of a spacer post for fastening circuit layers of the preferred embodiments shown in FIGS. 4 and 5;

FIG. 7 illustrates how a modified spacer post fastens a circuit layer onto a base member of the printed circuit board according to the present invention;

FIG. 8 illustrates how another modified spacer post fastens the circuit layer onto the base member of the printed circuit board according to the present invention; and

FIG. 9 is graph, illustrating the applied torque relative to loosening condition of the spacer post used in the printed circuit board of the present invention.

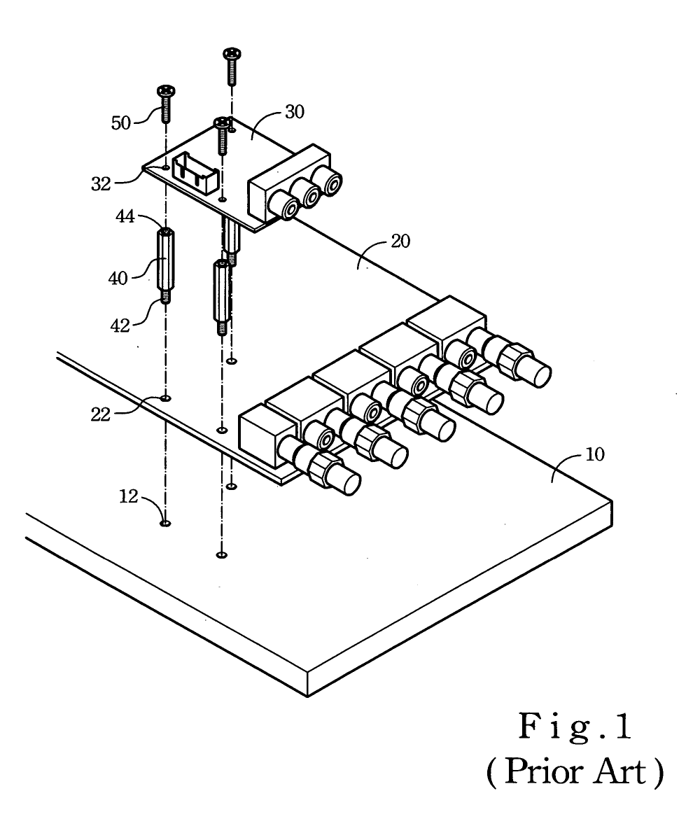

### DETAILED DESCRIPTIONS OF THE PREFERRED EMBODIMENTS

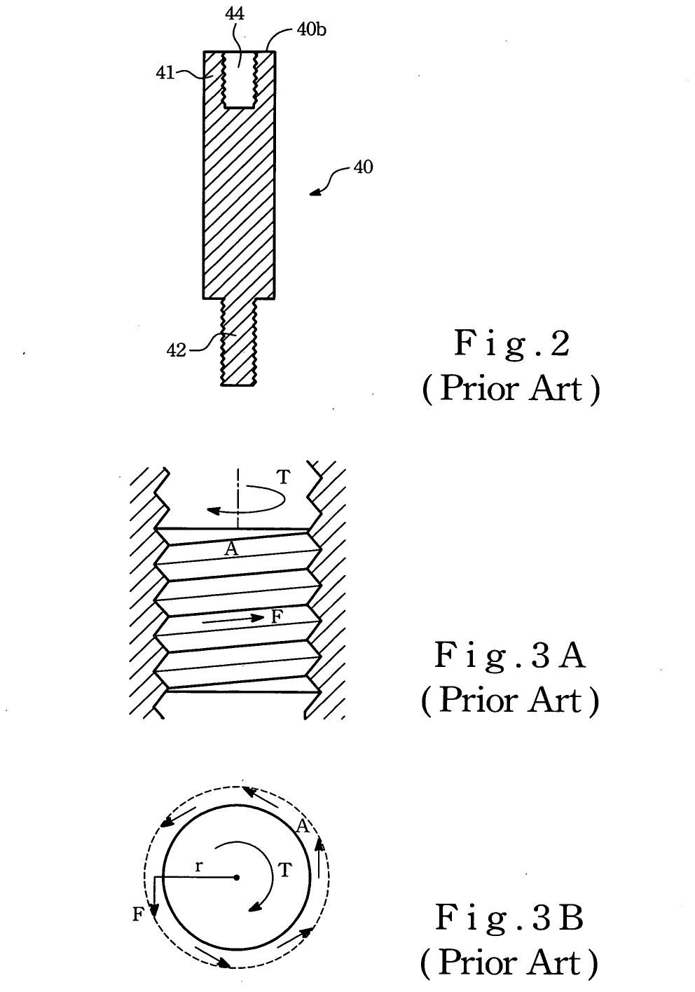

Referring to FIG. 2, the preferred embodiment of a multi-layered printed circuit board 20 of the present invention is used in an LCD device, and includes a base member 110, a lower circuit layer 120 disposed above the base member 110 and formed with a plurality of through holes 122, an upper circuit layer 130 disposed above the lower circuit layer 120 and formed with a plurality of through holes 132, a plurality of vertical spacer posts 40 disposed between the upper and lower circuit layers 130, 120 so as to space apart the circuit paths of the upper and lower circuit layers 130, 120 from one another and so as to prevent the electronic components (not visible) mounted on the upper and lower circuit layers 130, 120 from colliding one another, and a plurality of fastener screws 150.

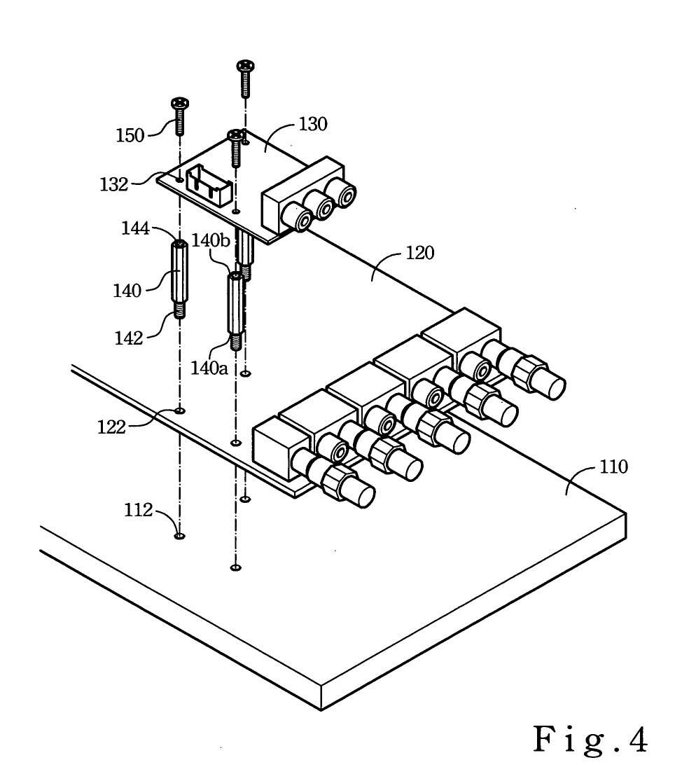

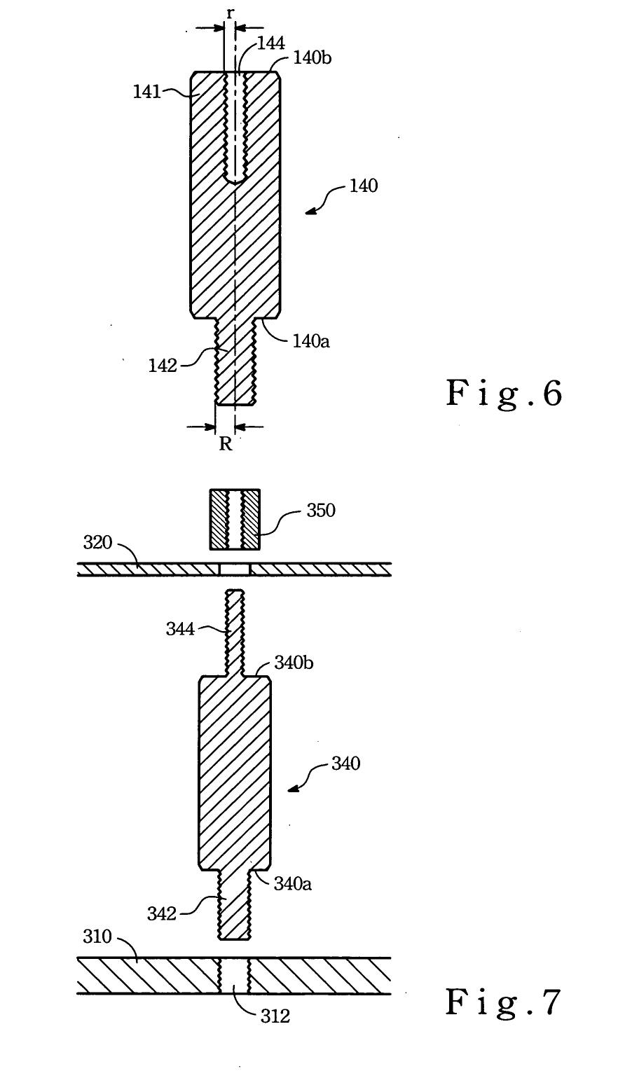

Referring to FIGS. 4 and 6, each of the spacer posts 140 includes an upper portion 141, a constricted threaded lower portion 142, and an abutment shoulder 140a between the upper and lower portions 141, 142. The upper portion 141 of each of the spacer posts 140 has an upper end face 140b abutting against the upper circuit layer 120 (not visible since the printed circuit board is shown in exploded view), and is formed with an inner threaded hole 44 extending inwardly and axially from the upper end face 140b. The abutment shoulder 140a of each of the spacer posts 140 abuts against the lower circuit layer 120 (not visible since the printed circuit board is shown in exploded view) to permit extension of the threaded lower portion 142 through the respective one of the through holes 122 in the lower circuit layer 120 to fasten threadedly the base member 110, thereby securing the lower circuit layer 120 on the base member 110.

Each of the fastener screws 150 extends through a respective one of the through holes 132 in the upper circuit layer 130 to fasten threadedly the inner threaded hole 144 in the upper portion of a respective one of the spacer posts 140, thereby securing the upper circuit layer 130 above the lower circuit layer 120 with a gap between the upper and lower circuit layers 130,120. Note that the base member 110 can be an outer casing of the LCD device or the outer casing of a CPU of a computer system. In order to enhance heat dissipation effect, the spacer posts 140 can be made from copper metal. Preferably, each of the spacer posts is constructed in such a manner to have multi-sided outer surface to facilitate turning of the same by an operating tool, such as a spanner or wrench.

Note that in the present preferred embodiment, the threaded lower portion 142 of each of the spacer posts 140 defines an outer diameter R that is greater an inner diameter r defined by the inner threaded hole 144 in the upper portion 141 of said each of the spacer posts 140, i.e. the radius R of the threaded lower portion 142>the radius of the inner threaded hole 144. However, the threaded lower portion 142 and the inner threaded hole 144 in the upper portion 141 of each of the spacer posts 140 can be arranged in such a manner to have the same screw pitch and the same pitch inclination. Referring again to FIGS. 3A and 3B, since the radius of the fastener screw 50 is equivalent the radius r of the inner threaded hole 144, and the radius of the threaded hole 112 in the base member 110 is equivalent the radius R of the threaded lower portion 142, the torque applied (T=F×r) onto the spacer post 140 for removal of the lower circuit layer 120 from the base member 110 is generally greater than that applied onto the fastener screw 150 for removal of the upper circuit layer 130 from the lower circuit layer 120. Under such a condition, during detaching the upper and lower circuit layers 130, 120 from the base member 110, the amount of torque applied onto the fastener screw 150 can result in timely removal of the upper circuit layer 130 from the lower circuit layer 120 prior to reaching the extent for removal of the lower circuit layer 120 from the base member 110.

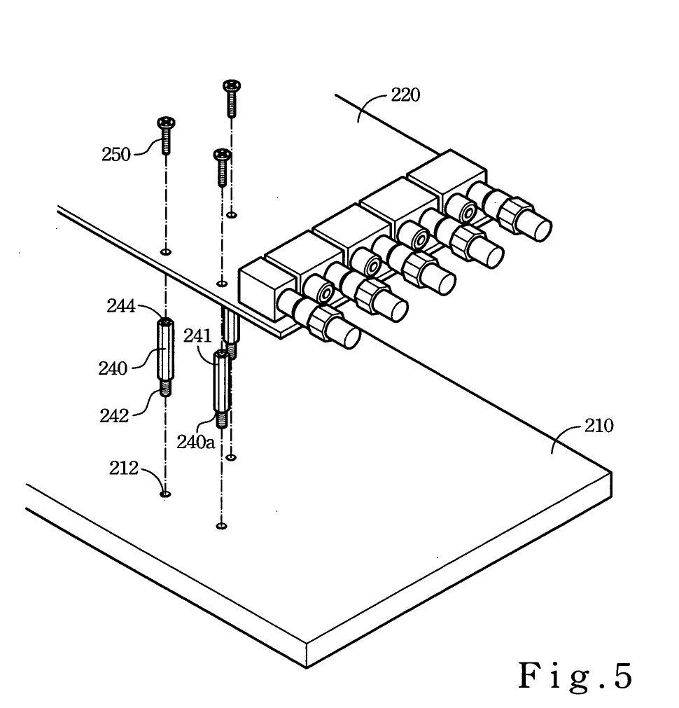

Referring to FIG. 5, in case the printed circuit board includes only one circuit layer 220 having electronic components mounted on top and bottom surfaces thereof. The spacer posts 240 are sandwiched between the base member 210 and the circuit layer 220 in such a manner that the abutment shoulder 240a of each of the spacer posts 240 abuts against the base member 210 (not visible since the printed circuit board is shown in exploded view) to engage the threaded hole 212 in base member 210, thereby securing the spacer post 240 uprightly on the base member 210. Each of the fastener screws 250 extends through a hole in the circuit layer 220 to fasten threadedly the inner threaded hole 244 in the upper portion 241 of a respective one of the spacer posts 140 so as to secure the circuit layer 220 above the base member 210 with a gap between the circuit layer 220 and the base member 210, thereby preventing the electronic components (not visible) from colliding against the base member 210 if mounted on the bottom surface of the circuit layer 220.

Referring to FIG. 7, a modified printed circuit board of the present invention includes the spacer post 340 in the form of a post body disposed between the base member 310 and a circuit layer 320 so as to support the circuit layer 320 above the base member 310 in cooperation with first and second fastening members 350, 312. The first fastening member 350 can be a nut while the second fastening member 312 is a threaded hole. As illustrated, the post body includes an upper portion 340b and a lower portion 340a. The lower portion 340a of the post body is formed with a second threaded member 342 that engages the threaded hole 312 in the base member 310. The upper portion 340b of the post body has an end face abutting against the circuit layer 320, and is formed with a first threaded member 344 extending through a hole in the circuit layer 320 to engage the nut 350 so as to secure the circuit layer 320 on the upper portion of the post body. The second threaded member 342 of the lower portion 340a of the post body defines a first diameter that is greater a second diameter defined by the first threaded member 344 of the upper portion of the post body such that a torque required to remove the second threaded member 342 is greater than that for removing the nut 350 from the first threaded member 344.

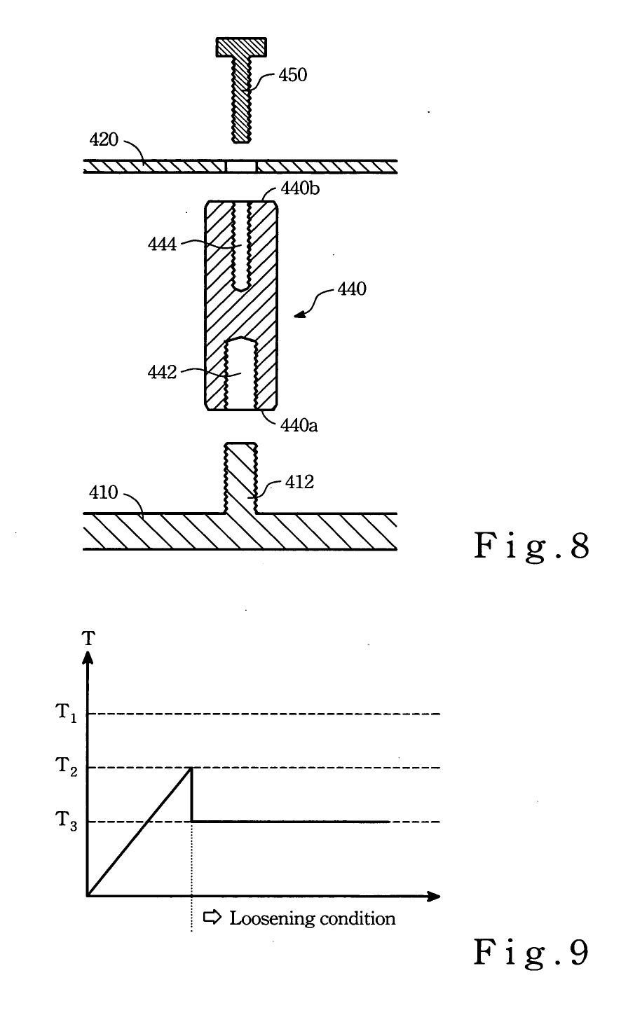

Referring to FIG. 8, another modified preferred embodiment of the present invention is shown to have the structure similar that of FIG. 7. The only difference resides in that each of the first and second threaded members 444, 442 of the post body 440 is a threaded hole while each of the first and second fastening members 450,412 is a screw rod that is adapted to engage a respective one of the threaded holes in the post body 440. The second threaded member 442 of the lower portion 440a of the post body 440 defines a first diameter that is greater a second diameter defined by the first threaded member 444 of the upper portion 440b of the post body 440.

FIG. 9 illustrates a graph representing the changes of the torque applied to the spacer post during loosening states of the spacer post. Assuming that, T₁ represents the torque required for removal of the threaded lower portion 142 of the spacer post 140 from the base member 110, T₂ represents the torque required for removal of the fastener screw 150 from the spacer post 140 (see FIG. 4), wherein T₁>T₂. It is noted that T2 represents the torque to overcome the static friction between the fastener screw and the spacer post so as to startup the rotation of the fastener screw. As the rotation of the fastener screw is started, the torque applied to the spacer post is reduced to T₃, which represents the torque to overcome the kinetic friction between the fastener screw and the spacer post. During the removing operation, even with a continuously increasing external toque applied on the fastener screw 150, the torque applied to the spacer post will never reaches the extent of T1 so as to permit removal of the upper circuit layer 130 from the lower circuit layer 120.

Some advantages provided by the multi-layered printed circuit board of the present invention as follows:
(i) By simply altering the structures of the threaded lower portion and the inner threaded hole in the upper portion of the spacer post 140, when removing the circuit layers from the printed circuit, damage caused to the electronic components mounted on the circuit layers can be avoided.
(ii) Since the circuit layers can be removed one after another in succession, time-waste problem encountered during removal of the circuit layers from the conventional printed circuit board can be eliminated.

While the present invention has been described in connection with what is considered the most practical and preferred embodiments, it is understood that this invention is not limited to the disclosed embodiments but is intended to cover various arrangements included within the spirit and scope of the broadest interpretation so as to encompass all such modifications and equivalent arrangements.

1. A spacer post for fastening upper and lower layers of a printed circuit board in cooperation with a fastener screw and a base member, each of the upper and lower layers being formed with a through hole, the spacer post comprising:
a post body adapted to be disposed between the upper and lower layers so as to space apart the lower and upper layers from each other, the post body including an upper portion having an end face that is adapted to abut against the upper layer and being formed with an inner threaded hole extending inwardly and axially from said end face, and a threaded lower portion extending through the through hole in the lower layer to fasten threadedly the base member disposed below the lower layer, wherein, said threaded lower portion of said post body defines an outer diameter that is greater an inner diameter defined by said inner threaded hole in said upper portion of said post body such that a torque required to remove said threaded lower portion from the base member is greater than that for removing the fastener screw from said threaded inner hole in said upper portion once the fastener screw extends through the through hole in the upper layer to fasten threadedly said threaded inner hole in said upper portion of said post body.

2. The spacer post according to claim 1, wherein said inner threaded hole in said upper portion and said threaded lower portion of said post body respectively have the same screw inclination.

3. The spacer post according to claim 1, wherein said inner threaded hole in said upper portion and said threaded lower portion of said spacer post respectively have the same screw pitch.

4. The spacer post according to claim 1, wherein said post body is made from copper metal.

5. A spacer post for spacing first and second layers in cooperation with first and second fastening members, each of the first and second layers being formed with a through hole, the spacer post comprising:
a post body adapted to be disposed on the second layer to support the first layer thereabove, and including an first portion having an end face that is adapted to abut against the first layer and being formed with a first threaded member that is adapted engage the first fastening member for securely mounting the first layer on said first portion of said post body, and a second portion formed with a second threaded member that is adapted to engage the second fastening member disposed below the second layer so as to immobilize the second layer, wherein a torque required to remove said second threaded member is greater than that for removing the first fastening member from said first threaded member.

6. The spacer post according to claim 5, wherein said second threaded member of said second portion of said post body defines a first diameter that is greater a second diameter defined by said first threaded member of said first portion of said post body.

7. The spacer post according to claim 5, wherein said first and second layers are upper and lower layers.

8. The spacer post according to claim 5, wherein the first fastening member is a nut engaging said first threaded member for securing said upper layer thereon, the second fastening member being a threaded hole engaging said second threaded member.

9. The spacer post according to claim 5, wherein each of said first and second threaded members is a threaded hole, each of the first and second fastening members being a screw rod that is adapted engage a respective one of said threaded holes.

10. The spacer post according to claim 5, wherein said first and second threaded members of said post body respectively have the same screw inclination.

11. The spacer post according to claim 5, wherein said post body is made from copper metal.

12. A printed circuit board for an LCD device, comprising:
a base member;
an upper circuit layer disposed above said base member and formed with a plurality of through holes;
a plurality of vertical spacer posts mounted uprightly on said base member for supporting said upper circuit layer thereabove, each of said spacer posts including an upper portion having an end face abutting against said upper circuit layer and being formed with an inner threaded hole extending inwardly and axially from said end face, and a threaded lower portion threadedly fastening said base member; and
a plurality of fastener screws, each of said fastener screws extending through a respective one of said through holes in said upper circuit layer to fasten threadedly said inner threaded hole in said upper portion of a respective one of said spacer posts;
wherein, said threaded lower portion of each of said spacer posts defines an outer diameter that is greater an inner diameter defined by said inner threaded hole in said upper portion of said each of said spacer posts.

13. The printed circuit board according to claim 12, further comprising a lower circuit layer that is disposed between said upper circuit layer and said base member and that is formed with a plurality of through holes, each of said spacer posts further having an abutment shoulder between said upper and lower portions thereof such that said abutment shoulder of a respective one of said spacer posts abuts said second circuit layer to permit extension of said threaded lower portion of the respective one of said spacer posts through a respective one of said through holes in said lower circuit layer to threadedly fasten said base member.

14. The printed circuit board according to claim 12, wherein said inner threaded hole in said upper portion and said threaded lower portion of said spacer post respectively have the same screw inclination.

15. The printed circuit board according to claim 12, wherein said inner threaded hole in said upper portion and said threaded lower portion of said spacer post respectively have the same screw pitch.

16. The printed circuit board according to claim 12, wherein each of said spacer posts is made from copper metal.
